(19) United States
(12) Patent Application Publication
(10) Pub. No.: US 2026/0320832 A1
(43) Pub. Date: Oct. 15, 2026

(54) ON-DEVICE SEMANTIC AUTO-CALIBRATION DEVICE AND METHOD

(71) Applicants: HYUNDAI MOTOR COMPANY, Seoul (KR); Kia Corporation, Seoul (KR)

(72) Inventors: Kyungzun RIM, Hwaseong-si (KR); Minkyu LEE, Hwaseong-si (KR); Jaeseon KIM, Hwaseong-si (KR)

(21) Appl. No.: 19/408,232

(22) Filed: Dec. 3, 2025

(30) Foreign Application Priority Data
Apr. 9, 2025 (KR) 10-2025-0045985

(51) Int. Cl. G06T 7/80; G06T 7/12; G06V 10/25

(52) U.S. Cl. CPC G06T 7/80; G06T 7/12; G06V 10/25

(57) ABSTRACT

An on-device semantic auto-calibration device for performing calibration of a robot using deep learning includes one or more memory devices configured to store program codes, and one or more processors configured to execute the program codes to perform operations. The operations include generating topographical characteristic information based on an RGB image and a depth image obtained through a camera disposed at the robot, and automatically performing extrinsic calibration of the camera based on the topographical characteristic information.

### CROSS-REFERENCE TO RELATED APPLICATION

This application claims priority to and the benefit of Korean Patent Application No. 10-2025-0045985 filed with the Korean Intellectual Property Office on Apr. 9, 2025, the entire contents of which are incorporated herein by reference.

### TECHNICAL FIELD

The present disclosure relates to an on-device semantic auto-calibration device and an on-device semantic auto-calibration method, and more particularly, to an on-device semantic auto-calibration device and an on-device semantic auto-calibration method which overcome temporal/spatial constraints to improve the efficiency of a calibration process.

### BACKGROUND

Camera extrinsic calibration is essential for inter-camera alignment and spatial coordinate transformation. In a multi-camera system, each camera’s coordinate system must be aligned to ensure consistent spatial mapping. The camera extrinsic calibration is also necessary to transform coordinate systems of individual cameras into one world coordinate system.

Further, the camera extrinsic calibration is also needed in sensor fusion and robot vision. To integrate data from sensors such as LiDAR, IMU, and GPS, the precise position and orientation of the camera must be known. The position

and the direction of the camera are required for data matching with other sensors in systems such as robots, autonomous vehicles, etc.

However, spatial constraints present significant challenges. For example, environmental setup requirements—such as installing a calibration board—can be restrictive and impractical in real-world deployments. This creates difficulties for on-device and online calibration. In non-overlapping field-of-view (FOV) scenarios, additional procedures are required, which may introduce errors.

Temporal constraints also pose problems, as configuring the environment and logging sufficient data can be time-consuming and operationally inefficient.

### SUMMARY

The present disclosure is directed to an on-device semantic auto-calibration device and an on-device semantic auto-calibration method which automate calibration by utilizing a semantic segmentation result obtained from an RGB image and topographical characteristics obtained by using depth information, in a complex environment with an obstacle.

According to one aspect of the present disclosure, an on-device semantic auto-calibration device for performing calibration of a robot using deep learning can include one or more memory devices configured to store program codes, and one or more processors configured to execute the program codes to perform operations. The operations can include generating topographical characteristic information based on an RGB image and a depth image obtained through a camera disposed at the robot, and automatically performing extrinsic calibration of the camera based on the topographical characteristic information.

In some implementations, generating the topographical characteristic information can include generating a point cloud representing a selectively determined specific terrain as the topographical characteristic information. In some examples, generating the point cloud for the specific terrain can include detecting a bounding box of the specific terrain using a text prompt-based object detection model, extracting a segmentation mask corresponding to the bounding box using a semantic segmentation model, and generating a semantic point cloud in a camera coordinate system based on the depth image, an intrinsic parameter of the camera, and the segmentation mask.

In some examples, the text prompt-based object detection model can include a GroundingDINO model, and the semantic segmentation model can include a segment anything model (SAM) or a segment anything model 2 (SAM2). In some implementations, automatically performing the extrinsic calibration can include performing the extrinsic calibration based on the semantic point cloud of the specific terrain.

In some examples, performing the extrinsic calibration can include transforming a reference coordinate system of the semantic point cloud from the camera coordinate system to a robot coordinate system, down-sampling the semantic point cloud to reduce noise, identifying a planar region by extracting point cloud data at a uniform height from the down-sampled semantic point cloud, and performing rotation and translation calibration on the planar point cloud such that a normal vector of the planar region is perpendicular to the robot coordinate system. In some examples, transforming the reference coordinate system can include generating a semantic point cloud in the robot coordinate system based on an initial extrinsic parameter and the semantic point cloud in the camera coordinate system.

In some implementations, down-sampling the semantic point cloud can include applying a voxel grid filter to the semantic point cloud to generate the down-sampled semantic point cloud. In some implementations, identifying the planar region can include detecting the plane including point cloud data at the same height using a region growing method, and calculating a normal vector and a centroid point of the detected plane using sample consensus (SAC) segmentation. In some examples, performing the rotation and translation calibration can include determining rotation calibration based on a difference between the normal vector and a vertical reference vector of the plane, and determining translation calibration based on a height difference of the centroid point.

According to another aspect of the present disclosure, an on-device semantic auto-calibration method performed by a computing device including a processor and a memory can include generating, by the processor, topographical characteristic information based on an RGB image and a depth image obtained through a camera disposed at a robot, and automatically performing, by the processor, extrinsic calibration of the camera based on the topographical characteristic information.

In some implementations, generating the topographical characteristic information comprises generating, by the processor, a point cloud representing a selectively determined specific terrain as the topographical characteristic information. In some examples, generating the point cloud for the specific terrain can include detecting, by the processor, a bounding box of the specific terrain using a text prompt-based object detection model, extracting, by the processor, a segmentation mask corresponding to the bounding box using a semantic segmentation model, and generating, by the processor, a semantic point cloud in a camera coordinate system based on the depth image, an intrinsic parameter of the camera, and the segmentation mask.

In some examples, the text prompt-based object detection model can include a GroundingDINO model, and the semantic segmentation model can include a segment anything model 2 (SAM2). In some implementations, automatically performing the extrinsic calibration can include performing, by the processor, the extrinsic calibration based on the semantic point cloud of the specific terrain.

In some examples, performing the extrinsic calibration can include transforming, by the processor, a reference coordinate system of the semantic point cloud from the camera coordinate system to a robot coordinate system, down-sampling, by the processor, the semantic point cloud to reduce noise, identifying, by the processor, a planar region by extracting point cloud data at a uniform height from the down-sampled semantic point cloud, and performing, by the processor, rotation and translation calibration on the planar the point cloud such that a normal vector of the planar region is perpendicular to the robot coordinate system. In some examples, transforming the reference coordinate system can include generating, by the processor, a semantic point cloud in the robot coordinate system based on an initial extrinsic parameter and the semantic point cloud in the camera coordinate system.

In some implementations, down-sampling the semantic point cloud can include applying, by the processor, a voxel grid filter to the semantic point cloud to generate the down-sampled semantic point cloud. In some implementations, identifying the planar region can include detecting, by the processor, the plane including point cloud data at the same height using a region growing method, and calculating a normal vector and a centroid point of the detected plane using sample consensus (SAC) segmentation. In some examples, performing the rotation and translation calibration can include determining, by the processor, rotation calibration based on a difference between the normal vector and a vertical reference vector of the plane, and determining, by the processor, translation calibration based on a height difference of the centroid point.

According to an exemplary implementations of the present disclosure, an on-device semantic auto-calibration device and an on-device semantic auto-calibration method can rapidly and efficiently perform calibration for a robot development process, by using deep learning.

According to an exemplary implementations of the present disclosure, an on-device semantic auto-calibration device and an on-device semantic auto-calibration method can automate calibration by utilizing a semantic segmentation result obtained from an RGB image and topographical characteristics obtained by using depth information, in a complex environment with an obstacle.

### BRIEF DESCRIPTION OF THE DRAWINGS

FIG. 1 is a block diagram illustrating an example of an on-device semantic auto-calibration device.

FIG. 2 is a block diagram illustrating an example of a preprocessing unit of FIG. 1.

FIG. 3 is a block diagram illustrating an example for describing the preprocessing unit of FIG. 2.

FIG. 4 is a flowchart illustrating an example for describing a preprocessing step.

FIG. 5 is a block diagram illustrating an example of the calibration unit of FIG. 1.

FIG. 6 is a block diagram illustrating an example of the calibration unit of FIG. 5.

FIG. 7 is a flowchart illustrating an example for describing a calibration step.

FIG. 8 is a diagram illustrating an example for describing a point cloud filtering step.

FIG. 9 is a diagram illustrating an example for describing a rotation and translation calibration step.

FIG. 10 is a diagram illustrating an example of a computing device.

### DETAILED DESCRIPTION

An on-device semantic auto-calibration device 1000 can execute program codes or instructions loaded on one or more memory devices through one or more processors.

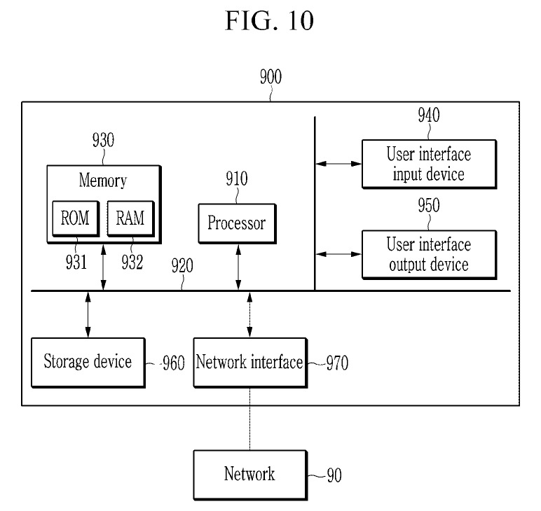

For example, the on-device semantic auto-calibration device 1000 can be implemented as a computing device 900 described below in relation to FIG. 10. For example, one or more processors can correspond to a processor 910 of the computing device 900, and one or more memory devices can correspond to a memory 930 of the computing device 900.

The program codes or instructions can be executed by one or more processors to perform calibration on a robot using deep learning. In this specification, the term “module” can be used to logically distinguish the functions of performing the program code or instruction.

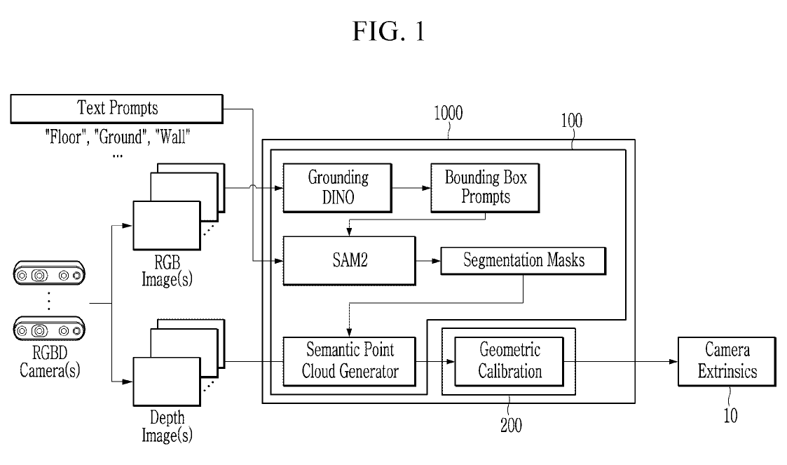

FIG. 1 is a block diagram illustrating an example of an on-device semantic auto-calibration device.

Referring to FIG. 1, an on-device semantic auto-calibration apparatus 1000 can include a preprocessing unit 100 and a calibration unit 200.

The on-device semantic auto-calibration device 1000 can rapidly and efficiently perform calibration in a robot development process by using the deep learning.

When an RGBD (red, green, blue-depth) camera is used, the on-device semantic auto-calibration device 1000 can automate calibration by using a semantic segmentation result obtained from an RGB image and topographical characteristics obtained by using depth information.

The preprocessing unit 100 can generate topographical characteristic information based on an RGB image and a depth image obtained through a camera at in the robot, and a text prompt.

Specifically, the preprocessing unit 100 can generate a semantic point cloud for a selectively determined terrain based on a bounding box extracted using a text prompt-based object detection model and a segmentation mask obtained using a semantic segmentation model.

For example, the preprocessing unit 100 can obtain a bounding box of a terrain to be utilized by using GroundingDINO to utilize various and accurate terrains, and obtain a semantic segmentation result by using SAM2.

Using the segmentation result and depth information, the preprocessing unit 100 can generate a semantic point cloud in the camera coordinate system for the selected terrain.

The calibration unit 200 can automatically perform extrinsic calibration of the camera on the robot based on the topographical characteristic information (or point cloud information) generated through preprocessing to output camera extrinsics 10 (external parameters).

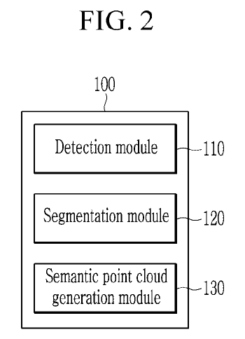

FIG. 2 is a block diagram illustrating an example of the preprocessing unit 100 of FIG. 1.

Referring to FIG. 2, the preprocessing unit 100 can include a detection module 110, a segmentation module 120, and a semantic point cloud generation module 130.

The detection module 110 can extract a bounding box of a specific terrain using a text prompt-based object detection model.

In some implementations, the text prompt-based object detection model can include a GroundingDINO model.

The GroundingDINO model can refer to an artificial intelligence model that finds an object in an image based on a natural language.

The segmentation module 120 can extract a segmentation mask for the bounding box using a semantic segmentation model.

The semantic segmentation model can include a segment anything model (SAM) or segment anything model 2 (SAM2).

The SAM can refer to a general-purpose artificial intelligence model that may segment any image. The SAM2 can be an upgraded version of the SAM.

The semantic point cloud generation module 130 can generate a semantic point cloud in a camera coordinate system for a specific terrain based on a depth image, an intrinsic parameter of a camera, and a segmentation mask.

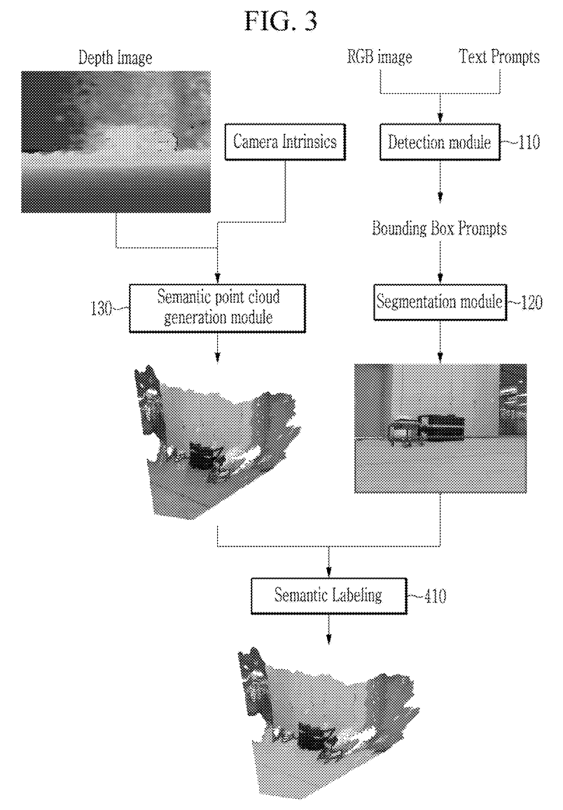

FIG. 3 is a block diagram illustrating an example of the preprocessing unit 100 of FIG. 2.

In FIG. 3, the detection module 110 can output a bounding box of a desired terrain using a GroundingDINO model or the like with an RGB image and text prompts as inputs.

For example, the detection module 110 can extend the type of terrain to be used for calibration.

The segmentation module 120 can perform semantic segmentation on a bounding box region found in the detection module 110 by using the SAM2 model or the like.

For example, the segmentation module 120 can output a pixel of a terrain selectively determined in the bounding box as an input of the bounding box.

The semantic point cloud generation module 130 can use the depth image, the camera intrinsic parameter, and the output of the segmentation module 120 to generate a semantic point cloud 410 corresponding to a floor, which is a terrain selected based on the camera coordinate system.

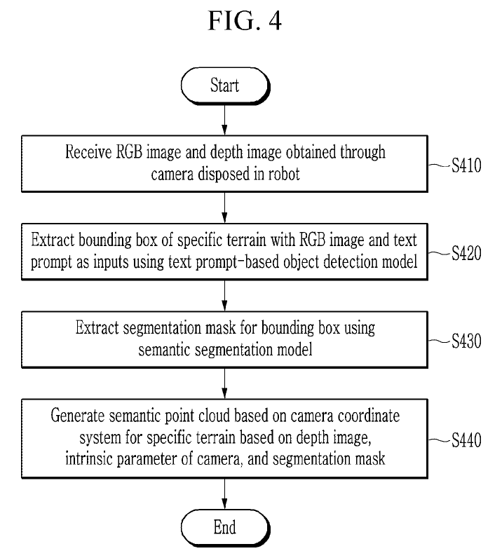

FIG. 4 is a flowchart illustrating an example for describing a preprocessing step. The preprocessing step of FIG. 4 can be performed through the preprocessing unit 100 of the on-device semantic auto-calibration device 1000 of FIG. 1.

The preprocess step can help maintaining accuracy of a calibration algorithm in a complex environment and utilizing various pieces of topographic information.

Since the on-device semantic auto-calibration device 1000 can accurately extract a point cloud of a desired terrain in units of pixels in the complex environment through the preprocessing step, the accuracy of calibration can be maintained in the calibration step. In addition, the on-device semantic auto-calibration device 1000 can have scalability to utilize other types of topographical information, such as an outer wall of the floor, through the preprocessing step.

In FIG. 4, the on-device semantic auto-calibration device 1000 can receive the RGB image and the depth image obtained through the camera disposed in the robot (step S410).

The on-device semantic auto-calibration device 1000 can output a bounding box of a specific terrain with the RGB image and the text prompt as inputs using a text prompt-based object detection model (step S420).

The on-device semantic auto-calibration device 1000 can extract a segmentation mask for the bounding box using the semantic segmentation model (step S430).

The on-device semantic auto-calibration device 1000 can generate a semantic point cloud in the camera coordinate system for the specific terrain based on the depth image, intrinsic parameters of the camera, and the segmentation mask (S440).

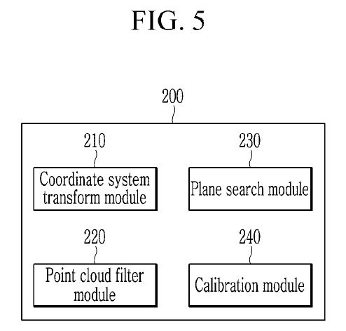

FIG. 5 is a block diagram illustrating an example of the calibration unit 200 of FIG. 1. The calibration unit 200 can calculate camera extrinsic by utilizing a point cloud of a selected terrain obtained through the preprocessing unit 100. For example, the selected terrain can include a “floor” and “ground” terrain.

The calibration unit 200 can calculate an accurate camera extrinsic by using that the floor and the ground are parallel to the robot in a wheel base robot.

Referring to FIG. 5, the calibration unit 200 can include a coordinate system transform module 210, a point cloud filter module 220, a plane search module 230, and a calibration module 240.

The coordinate system transform module 210 can transform a reference coordinate system of a semantic point cloud from a camera coordinate system to a robot coordinate system.

The point cloud filter module 220 can down-sample the semantic point cloud for noise filtering.

The plane search module 230 can search for a plane by outputting only a point cloud at the same height from the down-sampled semantic point cloud.

The plane search module 230 can detect the plane using a region growing method and calculate a normal vector and centroid point of the plane using SAC segmentation.

The calibration module 240 can perform rotation and translation calibration on the point cloud included in the searched plane such that a normal vector is vertical with respect to the robot coordinate system.

The calibration module 240 can determine rotation calibration based on a difference between the normal vector and a vertical reference vector of the plane, and determine translation calibration based on a height difference of the centroid point.

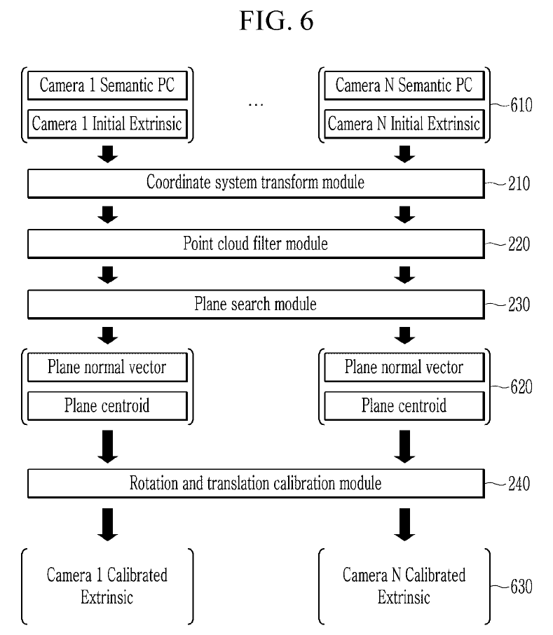

FIG. 6 is a block diagram illustrating an example of the calibration unit of FIG. 5.

In FIG. 6, the coordinate system transform module 210 can transform the reference coordinate system of a semantic point cloud from the camera coordinate system to the robot coordinate system by using an initial extrinsic parameter and a semantic point cloud 610.

The coordinate system transform module 210 may generate a semantic point cloud in the robot coordinate system by applying the initial camera extrinsic parameters (rotation and translation) to the semantic point cloud, leveraging the topographical feature that the robot and the floor are parallel.

The coordinate system transform module 210 can obtain the semantic cloud by measuring the initial camera extrinsic or utilizing hardware design data.

The coordinate system transform module 210 can receive, as input, a semantic point cloud for each camera and an initial extrinsic parameter (including rotation and translation) for each camera, and output a semantic point cloud referenced to the robot coordinate system for each camera.

The point cloud filter module 220 can generate a down-sampled semantic point cloud from the semantic point cloud using a Voxel grid filter.

The point cloud filter module 220 can reduce camera noise to increase the performance of plane detection.

The Voxel grid filter can be a technique used for down sampling of 3D point cloud data, which converts the point cloud to a smaller resolution to reduce the amount of data and improve processing speed.

The point cloud filter module 220 can output a down-sampled (filtered) semantic point cloud by applying the Voxel grid filter to the semantic point cloud labeled with a specific terrain, such as “floor.”

The plane search module 230 can detect a plane including a point cloud at the same height using a region growing method, and then calculate a normal vector of the plane and a centroid point 620 using SAC segmentation.

The region growing method can be one of the image processing techniques, which is mainly used for segmentation, and can use a method of gradually including adjacent pixels having similar properties, starting from an initial “seed” pixel, and expanding the region.

The plane search module 230 can first apply the region growing method to isolate a group of floor points at a uniform height, even when multiple floor levels are present, and then apply SAC (Sample Consensus) segmentation to calculate the normal vector and centroid point of the detected plane.

The plane search module 230 can output the semantic point cloud projected onto the detected plane using the filtered point cloud as input.

The calibration module 240 can obtain a rotation through a difference between a normal vector and a vertical vector of a plane, and obtain a translation by using a height difference of a centroid point.

The calibration module 240 can calculate a rotation such that the plane’s normal vector becomes perpendicular to the ground (robot coordinate system), and a translation such that the centroid point’s height aligns with the reference ground level.

Specifically, the calibration module 240 can determine the rotation based on the difference between the plane’s normal vector and a vertical reference vector (e.g., (0, 0, 1)), and determine the translation based on the height difference of the centroid point.

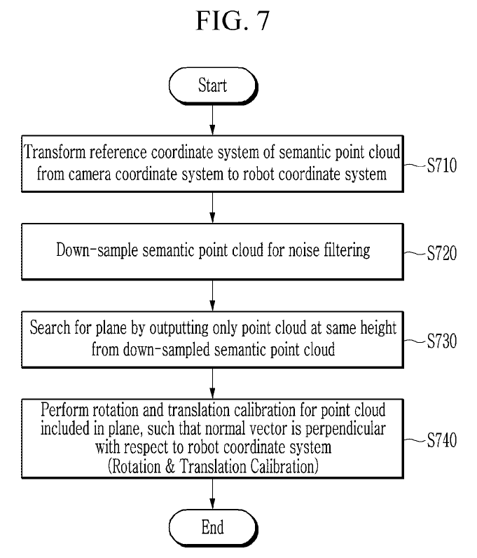

FIG. 7 is a flowchart illustrating an example for describing a calibration step. The calibration step of FIG. 7 can be performed through the calibration unit 200 of the on-device semantic auto-calibration device 1000 of FIG. 1.

In FIG. 7, the on-device semantic auto-calibration device 1000 can transform the reference coordinate system of the semantic point cloud from the camera coordinate system to the robot coordinate system (step S710).

The on-device semantic auto-calibration device 1000 can generate the semantic point cloud in the robot coordinate system by applying the initial extrinsic parameter to the semantic point cloud.

The on-device semantic auto-calibration device 1000 can down-sample the semantic point cloud for noise filtering (step S720).

The on-device semantic auto-calibration device 1000 can apply a Voxel grid filter to generate the down-sampled semantic point cloud.

The on-device semantic auto-calibration device 1000 can search for a plane by outputting only a point cloud at the same height from the down-sampled semantic point cloud (step S730).

The on-device semantic auto-calibration device 1000 can detect the plane using a region growing method and calculate the normal vector and centroid point using SAC segmentation.

The on-device semantic auto-calibration device 1000 can perform rotation and translation calibration on the point cloud included in the searched plane such that a normal vector is vertical with respect to the robot coordinate system (S740).

The on-device semantic auto-calibration device 1000 can determine the rotation based on the difference between the normal vector and a vertical reference vector, and determine the translation based on the height difference of the centroid point.

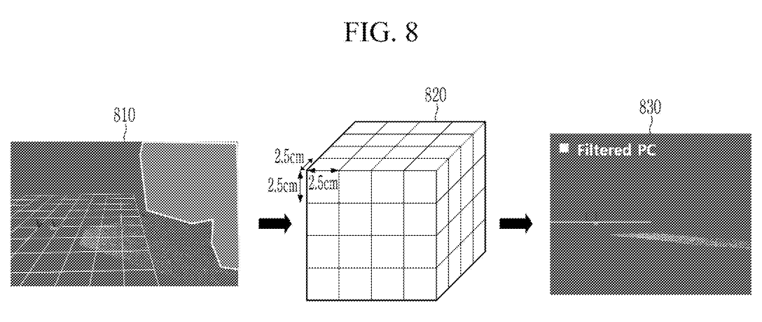

FIG. 8 is a diagram illustrating an example for describing a point cloud filtering step.

In FIG. 8, the on-device semantic auto-calibration device 1000 can output a down-sampled point cloud 830 after filtering the point cloud 810 labeled with “floor” using a 2.5 × 2.5 × 2.5 Voxel grid filter 820.

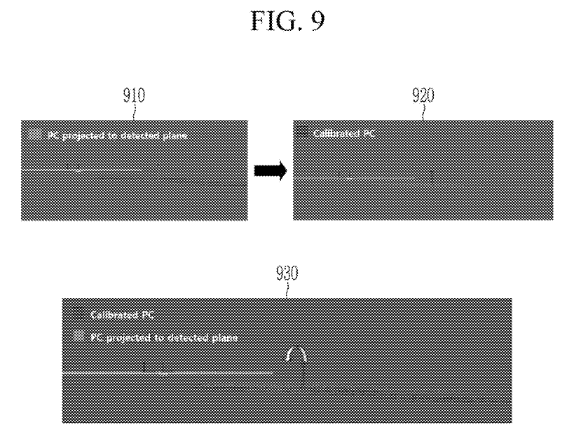

FIG. 9 is a diagram illustrating an example for describing a rotation and translation calibration step.

In FIG. 9, through a shape 910 in which the point cloud projected on the plane is viewed based on the robot coordinate system, it can be seen that the normal vector is not perpendicular but inclined with respect to the robot coordinate system.

Through a point cloud shape 920 after calibration, it can be seen that the normal vector is exactly perpendicular with respect to the robot coordinate system.

Through a comparison 930 based on the robot coordinate system before and after the calibration, a slope difference of the plane between pre-calibration and post-calibration can be confirmed.

FIG. 10 is a diagram illustrating an example of a computing device.

Referring to FIG. 10, the on-device semantic auto-calibration device and the on-device semantic auto-calibration method can be implemented by using a computing device 900.

The computing device 900 can include at least one of a processor 910, a memory 930, a user interface input device 940, a user interface output device 950, and a storage device 560 which communicate with each other through a bus 920. The computing device 900 can also include a network interface 970 electrically connected to a network 90. The network interface 970 can transmit or receive a signal to or from another entity through the network 90.

The processor 910 can be implemented as various types including a micro controller unit (MCU), an application processor (AP), a central processing unit (CPU), a graphic processing unit (GPU), and a neural processing unit (NPU), and can be an arbitrary semiconductor device that executes an instruction stored in the memory 930 or the storage device 960. The processor 910 can be configured to implement the functions and methods in relation to FIGS. 1-9.

The memory 930 and the storage device 960 can include various types of volatile or non-volatile storage media. For example, the memory can include a read only memory (ROM) 931 and a random access memory (RAM) 932. In some implementations, the memory 930 can be positioned inside or outside the processor 910 and connected to the processor 910 by various well-known means.

In some implementations, at least some components or functions of the on-device semantic auto-calibration device and the on-device semantic auto-calibration method can be implemented as a program or software executed by the computing device 900 or the program or software can be stored in a computer readable medium.

In some implementations, at least some components or functions of the on-device semantic auto-calibration device and the on-device semantic auto-calibration method implemented by using hardware or a circuit of the computing device 900 or as separate hardware or a separate which can be electrically connected to the computing device 900.

What is claimed is:

1. An on-device semantic auto-calibration device for performing calibration of a robot using deep learning, the device comprising:
one or more memory devices configured to store program codes; and
one or more processors configured to execute the program codes to perform operations comprising:
generating topographical characteristic information based on an RGB image and a depth image obtained through a camera disposed at the robot, and
automatically performing extrinsic calibration of the camera based on the topographical characteristic information.

2. The on-device semantic auto-calibration device of claim 1, wherein generating the topographical characteristic information comprises:
generating a point cloud representing a selectively determined specific terrain as the topographical characteristic information.

3. The on-device semantic auto-calibration device of claim 2, wherein generating the point cloud for the specific terrain comprises:
detecting a bounding box of the specific terrain using a text prompt-based object detection model,
extracting a segmentation mask corresponding to the bounding box using a semantic segmentation model, and
generating a semantic point cloud in a camera coordinate system based on the depth image, an intrinsic parameter of the camera, and the segmentation mask.

4. The on-device semantic auto-calibration device of claim 3, wherein the text prompt-based object detection model comprises a GroundingDINO model, and the semantic segmentation model comprises a segment anything model (SAM) or a segment anything model 2 (SAM2).

5. The on-device semantic auto-calibration device of claim 3, wherein automatically performing the extrinsic calibration comprises:
performing the extrinsic calibration based on the semantic point cloud of the specific terrain.

6. The on-device semantic auto-calibration device of claim 5, wherein performing the extrinsic calibration comprises:
transforming a reference coordinate system of the semantic point cloud from the camera coordinate system to a robot coordinate system,
down-sampling the semantic point cloud to reduce noise,
identifying a planar region by extracting point cloud data at a uniform height from the down-sampled semantic point cloud, and
performing rotation and translation calibration on the planar point cloud such that a normal vector of the planar region is perpendicular to the robot coordinate system.

7. The on-device semantic auto-calibration device of claim 6, wherein transforming the reference coordinate system comprises:
generating a semantic point cloud in the robot coordinate system based on an initial extrinsic parameter and the semantic point cloud in the camera coordinate system.

8. The on-device semantic auto-calibration device of claim 6, wherein down-sampling the semantic point cloud comprises:
applying a voxel grid filter to the semantic point cloud to generate the down-sampled semantic point cloud.

9. The on-device semantic auto-calibration device of claim 6, wherein identifying the planar region comprises:
detecting the plane including point cloud data at the same height using a region growing method, and
calculating a normal vector and a centroid point of the detected plane using sample consensus (SAC) segmentation.

10. The on-device semantic auto-calibration device of claim 9, wherein performing the rotation and translation calibration comprises:
determining rotation calibration based on a difference between the normal vector and a vertical reference vector of the plane, and
determining translation calibration based on a height difference of the centroid point.

11. An on-device semantic auto-calibration method performed by a computing device including a processor and a memory, the method comprising:
generating, by the processor, topographical characteristic information based on an RGB image and a depth image obtained through a camera disposed at a robot; and
automatically performing, by the processor, extrinsic calibration of the camera based on the topographical characteristic information.

12. The on-device semantic auto-calibration method of claim 11, wherein generating the topographical characteristic information comprises:
generating, by the processor, a point cloud representing a selectively determined specific terrain as the topographical characteristic information.

13. The on-device semantic auto-calibration method of claim 12, wherein generating the point cloud for the specific terrain comprises:
detecting, by the processor, a bounding box of the specific terrain using a text prompt-based object detection model,
extracting, by the processor, a segmentation mask corresponding to the bounding box using a semantic segmentation model, and
generating, by the processor, a semantic point cloud in a camera coordinate system based on the depth image, an intrinsic parameter of the camera, and the segmentation mask.

14. The on-device semantic auto-calibration method of claim 13, wherein the text prompt-based object detection model comprises a GroundingDINO model, and the semantic segmentation model comprises a segment anything model 2 (SAM2).

15. The on-device semantic auto-calibration method of claim 13, wherein automatically performing the extrinsic calibration comprises:
performing, by the processor, the extrinsic calibration based on the semantic point cloud of the specific terrain.

16. The on-device semantic auto-calibration method of claim 15, wherein:
performing the extrinsic calibration comprises:
transforming, by the processor, a reference coordinate system of the semantic point cloud from the camera coordinate system to a robot coordinate system,
down-sampling, by the processor, the semantic point cloud to reduce noise,
identifying, by the processor, a planar region by extracting point cloud data at a uniform height from the down-sampled semantic point cloud, and
performing, by the processor, rotation and translation calibration on the planar the point cloud such that a normal vector of the planar region is perpendicular to the robot coordinate system.

17. The on-device semantic auto-calibration method of claim 16, wherein transforming the reference coordinate system comprises:
generating, by the processor, a semantic point cloud in the robot coordinate system based on an initial extrinsic parameter and the semantic point cloud in the camera coordinate system.

18. The on-device semantic auto-calibration method of claim 16, wherein down-sampling the semantic point cloud comprises:
applying, by the processor, a voxel grid filter to the semantic point cloud to generate the down-sampled semantic point cloud.

19. The on-device semantic auto-calibration method of claim 16, wherein identifying the planar region comprises:
detecting, by the processor, the plane including point cloud data at the same height using a region growing method, and
calculating a normal vector and a centroid point of the detected plane using sample consensus (SAC) segmentation.

20. The on-device semantic auto-calibration method of claim 19, wherein performing the rotation and translation calibration comprises:
determining, by the processor, rotation calibration based on a difference between the normal vector and a vertical reference vector of the plane, and
determining, by the processor, translation calibration based on a height difference of the centroid point.
